(19) United States
(12) Patent Application Publication
(10) Pub. No.: US 2025/0142305 A1
(43) Pub. Date: May 1, 2025

(54) ECS DISCOVERY ASSOCIATED WITH ROAMING

(71) Applicant: INTERDIGITAL PATENT HOLDINGS, INC., Wilmington, DE (US)

(72) Inventors: Michael Starsinic, Newtown, PA (US); Michel Roy, Candiac (CA); Kevin Di Lallo, Laval (CA); Robert Gazda, Spring City, PA (US); Taimoor Abbas, Sainte-Julie (CA)

(73) Assignee: INTERDIGITAL PATENT HOLDINGS, INC., Wilmington, DE (US)

(21) Appl. No.: 18/836,434

(22) PCT Filed: Feb. 7, 2023
(86) PCT No.: PCT/US2023/012473

§ 371 Date: Aug. 7, 2024

Related U.S. Application Data
(60) Provisional application No. 63/307,503, filed on Feb. 7, 2022.

(51) Int. Cl. H04W 4/50; H04W 8/08; H04W 48/18; H04W 84/04

(52) U.S. Cl. CPC H04W 4/50; H04W 8/08; H04W 48/18; H04W 84/042

(57) ABSTRACT

A network node, e.g., an edge configuration server (ECS), associated with a first PLMN may receive a first message from a WTRU. The first message may indicate a request to be notified if a type of network node, e.g., an ECS, becomes available to be accessed by the WTRU. The network node may receive a second message from a second network node. The second message may indicate an identity of a second PLMN and may indicate that the WTRU has become registered with the second PLMN. The network node may determine that a third network node of the type of network node, e.g., an ECS, is available to be accessed by the WTRU in the second PLMN. The network node may determine local breakout (LBO) information for the WTRU to establish a LBO packet data unit (PDU) session in the second PLMN and access the third network node.

### CROSS-REFERENCE TO RELATED APPLICATION

This application claims the benefit of U.S. Provisional Patent Application No. 63/307,503, filed Feb. 7, 2022, the contents of which are hereby incorporated herein by reference.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are disclosed herein for edge configuration server (ECS) discovery associated with roaming. Events may be detected by the ECS and used as a trigger to send ECS address configuration information so that a WTRU has information to establish a connection with an ECS in a visited public land mobile network (VPLMN).

Systems, methods, and instrumentalities are disclosed for receiving a request from a WTRU to be notified that a type of network node has become available to the WTRU in a visited public land mobile network (PLMN) and for providing configuration information for creating a session with a network node of the type in the visited PLMN.

A WTRU may be configured to send a first message to a network node associated with a first PLMN. The network node, which may be, for example, an edge configuration server (ECS), may be associated with the first PLMN and may be configured to receive the first message from the WTRU. The first message may indicate a request for information about the availability of a type of network node to be accessed by the WTRU. The first message may indicate, for example, to be notified if a type of network node becomes available to be accessed by the WTRU. The first message may be, for example, a service provisioning subscription request. The network node may respond with a service provisioning subscription response.

The network node may receive a second message from a second network node which may be, for example, a Network Exposure Function (NEF). The second message may indicate an identity of a second PLMN and may indicate that the WTRU may be registered with the second PLMN. The second message may comprise a notification response, e.g., an Nnef_EventExposure_Notify response, generated in response to a subscription request, e.g., an Nnef_EvenExposure_Subscribe request, forwarded by the network node to the second network node.

The network node may determine that a third network node of the type of network node may be available to be accessed by the WTRU via the second PLMN. The third network node may be, for example, an ECS. The network node may determine service provisioning information that the WTRU may use to access the third network node. For example, the network node may determine local breakout (LBO) information which may comprise information for the WTRU to establish a LBO packet data unit (PDU) session in the second PLMN and access the third network node. The LBO information may comprise, for example, a data network name (DNN), single-network slice selection assistance information (S-NSSAI), and/or an identifier associated with the second PLMN. The network node may send a third message comprising the LBO information to the WTRU.

The WTRU may receive the third message from the network node. The WTRU may establish a PDU session with the third network node via the second PLMN using the LBO information. For example, the WTRU may establish a PDU session with the third network node using the DNN and S-NSSAI received in the third message. The WTRU may access the third network node to perform a service provisioning procedure and may communicate with a fourth network node in the second PLMN to access edge services.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example architecture that may allow a WTRU to consume services from edge application servers.

FIG. 3 is a diagram illustrating an example flow for providing discovery of visited public land mobile network (VPLMN) edge configuration server (ECS) information and connection establishment.

FIG. 4 is a diagram illustrating an example flow for providing discovery of VPLMN ECS information and connection establishment with steering of roaming (SoR).

FIG. 5 is a diagram illustrating an example flow for moving a WTRU to a VPLMN and/or for obtaining access to an ECS.

### DETAILED DESCRIPTION

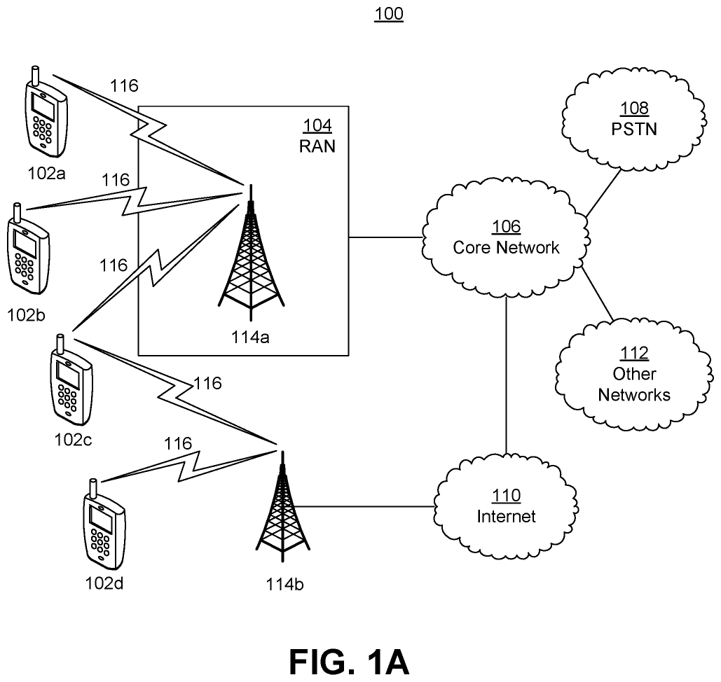

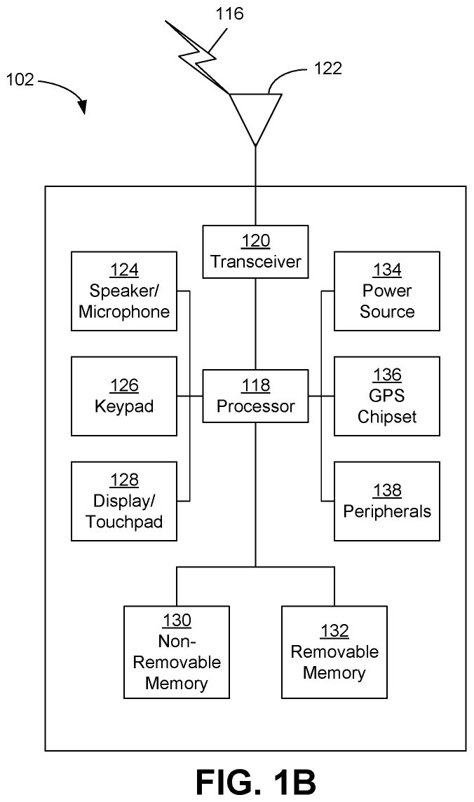

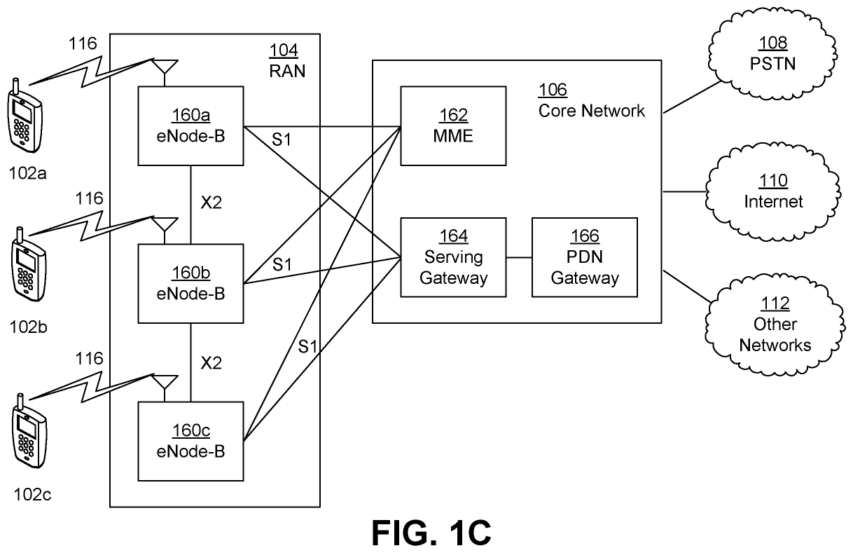

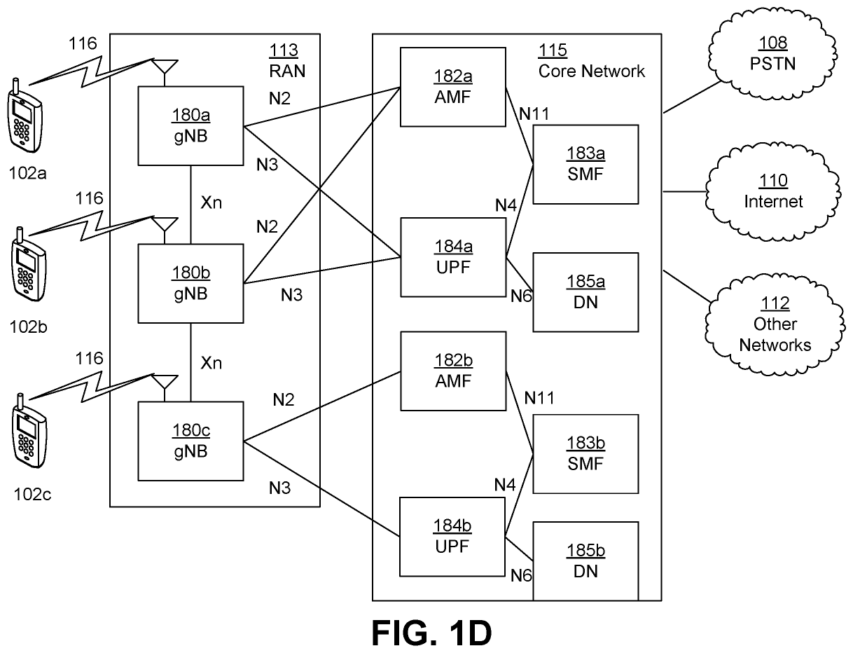

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted herein, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted herein, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

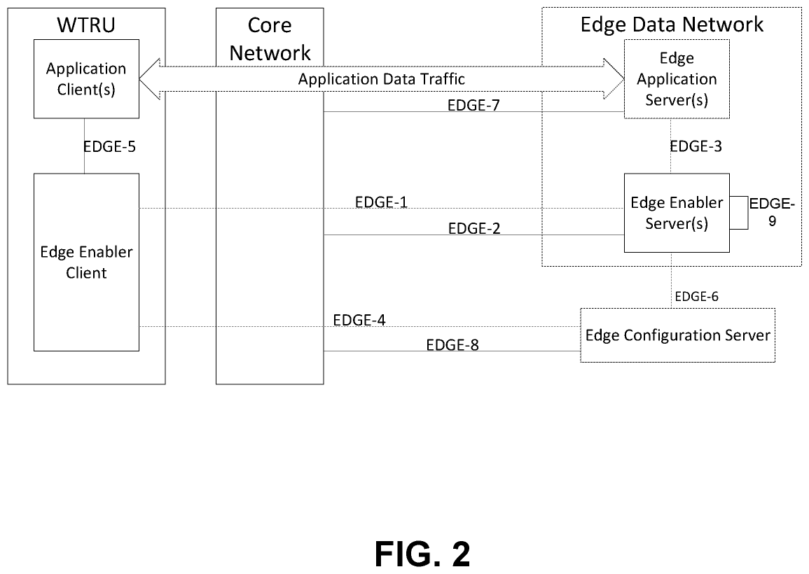

An application layer may be used for supporting edge service(s). An application layer architecture may be used for providing edge services. FIG. 2 shows an example architecture that may allow a WTRU to consume services from edge application servers. An architecture picture of an edge services application layer is shown in FIG. 2. An edge configuration server (ECS) may be provided. The ECS may be a server that provides services to an edge enabler client (EEC). The EEC may be a client that may be hosted in the WTRU and provides services to application clients (ACs) that may be hosted in the WTRU.

Provisioning may be a service that the ECS provides to the EEC. The ECS may provision edge data network (EDN) configuration information to the EEC. The EDN configuration information may include information about edge enabler server(s) (EES(s)) that may be available to the EEC. The EDN configuration information may include information that the EEC may use to establish a connection with the EES(s).

The EEC may receive information from the ECS about one or more EES(s). The EEC may use the information to contact and/or register with the EES(s).

ECS discovery may be a procedure by which an EEC may be configured with information about how to contact an ECS. The information for how to contact an ECS may include uniform resource identifier(s) (URI(s)), fully qualified domain name(s) (FQDN(s)), and/or internet protocol (IP) address(es)) of ECS(s). The information may include the ECS provider identifier(s) that may be associated with ECS(s). As described herein, the information may include spatial validity conditions for an ECS (e.g., each ECS). The spatial validity conditions may include a geographical service area, a list of tracking area(s) TA(s), and/or a list of countries (e.g., list of mobile country codes (MCCs) where the ECS may be accessed. The information may collectively be called ECS address configuration information.

ECS discovery may be based on ECS address configuration information that may be provisioned in the EEC, provisioned in an application client, and/or configured by a user of the WTRU (e.g., via a graphical user interface (GUI).

If the WTRU establishes a protocol data unit (PDU) session, the WTRU may indicate in the protocol configuration options (PCO) that it supports the ability to receive ECS address configuration information via non-access stratum (NAS) and to transfer the ECS address configuration information to the EEC(s). If the WTRU supports the feature, the WTRU may receive ECS address configuration information from the session management function (SMF) via PCO during PDU session establishment and/or during PDU session modification procedures. Unless the WTRU is roaming and using local breakout (LBO), the SMF in the home PLMN (HPLMN) may, e.g., may always, provide the PCO and the ECS address configuration may come from the HPLMN.

ECS address configuration information may be derived from an HPLMN identifier in non-roaming scenarios or from a VPLMN identifier in roaming scenarios.

ECS address configuration information may include the information that is listed in Table 1.

TABLE 1
ECS address configuration information

| Information Element | Description |
|---|---|
| ECS contact information | The ECS contact information may be an |
| | FQDN(s) and/or IP Address(es) of edge |
| | configuration servers. |
| ECS provider ID | The ECS provider ID may be an identifier |
| | of the edge configuration server (ECS) |
| | Provider (e.g., edge computing service |
| | provider). |
| spatial validity conditions | Spatial validity conditions may be a |
| | geographical service area, list of TAls, or |
| | countries where the ECS may be accessed. |

Steering of roaming may be provided. Steering of roaming may be a technique whereby a roaming WTRU may be encouraged to roam to a preferred roamed-to-network indicated by the HPLMN.

A steering of roaming application function (SOR-AF) may be an application function that may provide a User Data Management (UDM) with a list of preferred PLMN/access technology combination(s). The UDM may provide the preferred PLMN/access technology combinations to the access and mobility function (AMF) and the AMF may send the preferred PLMN/access technology combinations to the WTRU via an NAS message. The NAS message that carries the preferred PLMN/access technology combinations may be a registration accept message and the information element that carries the preferred PLMN/access technology combinations to the WTRU may be the SOR transparent container.

The SOR-AF may provide an application programming interface (API) that may be invoked by the UDM. The API may include Nsoraf_SoR_Get and/or Nsoraf_SoR_Response service operations. The Nsoraf_SoR_Get service operation may be used by the UDM to request SoR information for a WTRU and/or the Nsoraf_SoR_Response service operation may be used by the SOR-AF to provide SoR information to the UDM.

If the WTRU is roaming, the edge computing resources that are available to the WTRU may change. For example, if the WTRU moves from one PLMN to a second PLMN, the services that are offered by the second PLMN may be different than the services that are offered by the first PLMN.

As described herein, communication between an EEC in the WTRU and an ECS in the network may be how the EEC discovers what services are available to the EEC. Multiple approaches for how an EEC may discover ECS(s) that are available in an HPLMN may be supported. The ability for an EEC to discover what ECS(s) are available in a VPLMN may be limited.

ECS address configuration information may be derived from a VPLMN identifier when roaming. The approach, e.g., where an ECS identifier may be derived, e.g., only derived, from a VPLMN identifier, may allow, e.g., only allow, the EEC to discover a single ECS of the VPLMN. The discovery operation may not take into account the WTRU's location, subscription, desired services, or the fact that the network operator may have multiple ECS deployed.

The WTRU may receive ECS address configuration information from the VPLMN if the WTRU is using an LBO connection. The WTRU may know a data network name (DNN)/single-network slice selection assistance information (S-NSSAI) combination that may be used to establish an LBO connection that may be used to obtain ECS address configuration information and/or to communicate with an ECS. The home network operator may prefer to avoid allowing the WTRU to use an LBO connection so that traffic, e.g., all or most traffic, may be routed, e.g., or controlled by, the home network. The system may allow the home network to provide the WTRU with ECS address configuration information for ECS(s) in VPLMN(s). The feature may allow the WTRU to discover services in the VPLMN and/or give the HPLMN a measure of control over what service(s) the WTRU discovers in the VPLMN and when the WTRU discovers service(s) in the VPLMN.

The home network may use the application layer infrastructure of the system described herein to provide the WTRU with ECS address configuration information for ECS(s) in VPLMN(s). The WTRU may use the information to perform service provisioning with ECS(s) in a VPLMN. Events may be detected by the ECS and used as a trigger to send ECS address configuration information and the ECS address configuration information may be enhanced so that the WTRU may have enough information to establish a connection with an ECS in the VPLMN.

The ECS may use the steering of roaming feature in the system to steer the WTRU towards a VPLMN that may provide the WTRU with access to a suitable ECS.

The home network may use the NAS infrastructure of the system to provide the WTRU with ECS address configuration information for ECS(s) in VPLMN(s).

Application layer-based redirection may be used herein. The EEC may send a service provisioning subscription request to the ECS. The subscription request may include connectivity information such as a PLMN ID and/or service set identifier (SSID). The service provisioning subscription request may be enhanced to include an indication that the EEC desires to be notified if an ECS (e.g., new ECS) becomes available to the WTRU.

The ECS may be triggered to send a service provisioning notification to the EEC. The service provisioning notification may include a list of EDN configuration information. The list of EDN configuration information may include information about EES(s). The service provisioning notification may be triggered if the ECS detects that the WTRU may be in a location (e.g., new location). The ECS may use pre-provisioned policies and/or information that was provided in the AC profiles in the service provisioning subscription request to determine what EES information to send to the EEC.

The service provisioning notification may be enhanced to include ECS address configuration information. The ECS may be triggered to send the ECS address configuration information, for example, if the ECS receives a service provisioning subscription request from the EEC with new connectivity information or if the ECS detects that the WTRU has moved to a VPLMN.

The ECS may be triggered to send ECS address configuration information to the EEC, for example, if the ECS receives a monitoring event notification from the network exposure function (NEF). For example, the ECS may invoke the Nnef_EventExposure_Subscribe service operation of the NEF to indicate to the NEF that the ECS wants to be notified if the WTRU that hosts the EEC may be roaming and that the ECS wants to be notified of the WTRU's PLMN ID. The NEF may invoke the Nnef_EventExposure_Notify service operation to the ECS if the WTRU may be roaming. The Nnef_EventExposure_Subscribe service operation may be used to provide a roaming indication and/or PLMN ID to the ECS. The Nnef_EventExposure_Subscribe and Nnef_EventExposure_Notify services may be called a MonitoringEvent API. If the ECS receives a roaming status indication and/or a PLMN ID for the WTRU that hosts the EEC, the ECS may be triggered to send ECS address configuration information to the EEC.

The ECS address configuration information that may be sent to the EEC may include the information that is listed in Table 1 herein and may be enhanced to include PLMN ID(s). The PLMN ID(s) may be used to indicate the PLMNs where the ECSs may be accessible. If the EEC receives ECS address configuration information, the EEC may be triggered to perform a service provisioning procedure with one of the ECSs that are identified in the ECS address configuration information. The EEC may receive information from the mobile termination (MT) part of the WTRU that triggers the EEC to perform a service provisioning procedure with one of the ECSs. The information that is received from the MT part of the WTRU may include a roaming indication and/or a PLMN ID, and the EEC may use the PLMN ID to determine what ECS to contact for service provisioning.

The ECS address configuration information may be enhanced to include a DNN and/or S-NSSAI. If the WTRU determines that it is in a PLMN where it wants to contact an ECS, the WTRU may use the DNN/S-NSSAI combination when establishing a PDU Session to communicate with the ECS. Providing the DNN and/or S-NSSAI that may be used by the WTRU in the VPLMN may allow for the DNN/S-NSSAI combination to be used by the network to trigger a LBO session that may be used to access the associated ECS. Table 2 lists the information that may be sent in the ECS address configuration information and includes the information to support the WTRU in forming a connection to an ECS in the VPLMN.

TABLE 2
Enhanced - ECS Address Configuration Information

| Information Element | Description |
|---|---|
| ECS contact | The ECS contact information may be an |
| information | FQDN(s) and/or IP Address(es) of edge |
| | configuration servers. |
| ECS provider ID | The ECS provider ID may be an identifier |
| | of the edge configuration server (ECS) |
| | provider (e.g., edge computing service |
| | provider). |
| spatial validity | Spatial validity conditions may be a |
| conditions | geographical service area, list of |
| | TAls, or countries where the ECS may |
| | be accessed. |
| PLMN ID | The PLMN ID may be the identity of the |
| | PLMN that provides access to the ECS. |
| DNN/S-NSSAI | The DNN/S-NSSAI combination may be the |
| Combination | information that the WTRU provides to |
| | the network during PDU session |
| | establishment to ensure |
| | that the PDU Session is anchored in a |
| | data network that may be used to reach |
| | the ECS. |
| Service type information | The service type information may be used |
| | by the WTRU to check what type of |
| | services the ECS is associated with. For |
| | example, what types of EES(s) can the ECS |
| | help discover may be provided. The WTRU |
| | may use the information to determine what |
| | ECS(s) to contact for service provisioning. |

The instrumentalities described herein may give the ECS the option to send multiple sets of ECS address configuration information to the EEC and a set of ECS address configuration information (e.g., each set of ECS address configuration information) may be associated with different PLMN ID(s). The EEC may determine what ECSs to contact when it receives a PLMN ID from the MT part of the UE. For example, the EEC may store the ECS address configuration information, use the ECS address configuration information if it detects a PLMN change, and/or may not need to request ECS address configuration information (e.g., new ECS address configuration information) if there may be a PLMN change.

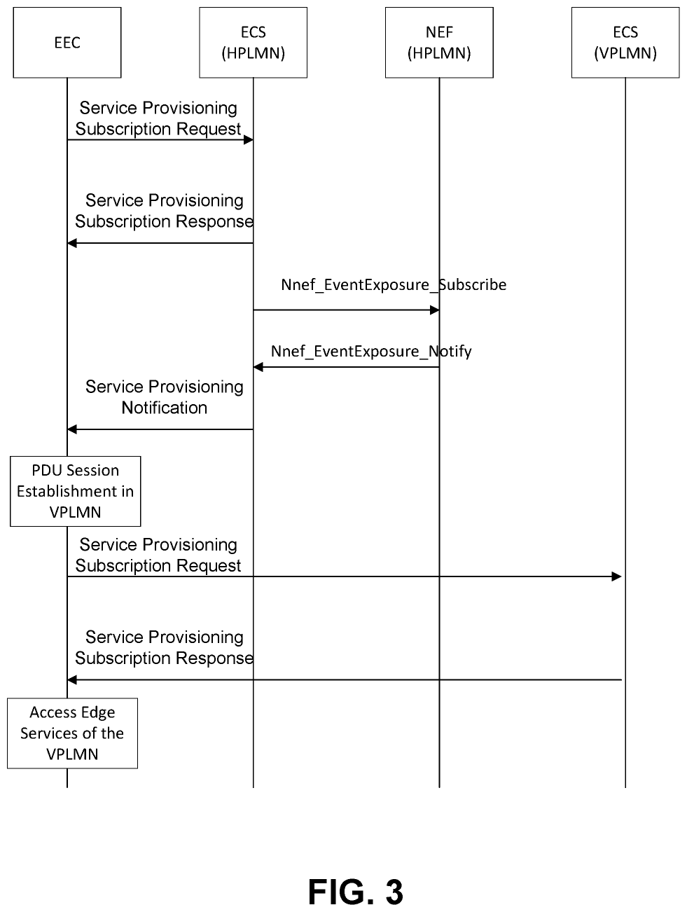

FIG. 3 depicts a flow for an example discovery of VPLMN ECS information and connection establishment. As shown in FIG. 3, a procedure for how the EEC may execute an enhanced service provisioning procedure with an ECS in the HPLMN to connect to and/or receive provisioning information from an ECS in the VPLMN may be provided. The EEC may send a service provisioning subscription request to the ECS. The subscription request may include connectivity information such as a PLMN ID and/or SSID and an indication that the EEC desires to be notified if an ECS (e.g., a new ECS) becomes available to the WTRU. The ECS may respond to the EEC's service provisioning request.

The ECS may use the Nnef_EventExposure service of the NEF to request the roaming status of the WTRU and/or the ID of the PLMN that the WTRU is registered with. The ECS may receive a notification of whether the WTRU is roaming and/or the identity of the PLMN that the WTRU is registered to. The ECS may send service provisioning information to the WTRU. The service provisioning information may point the WTRU to ECS(s) that are associated with the PLMN that was indicated when the ECS received the notification as described herein. The service provisioning information may include the information from Table 2. The WTRU may use the DNN/S-NSSAI combination that was received to establish a PDU session. The PDU Session may be an LBO session (e.g., anchored in the VPLMN). The EEC may use the PDU Session to communicate with an ECS in the VPLMN and execute a service provisioning procedure. The WTRU may be able to access edge services (e.g., EES(s) of the VPLM.

Application layer-based redirection may be provided. The WTRU may determine the PLMN ID of the network that it is registered to and the PLMN ID may point the WTRU to an ECS that lists other ECS that are available to the WTRU in the VPLMN.

As described herein, the WTRU may determine contact information (e.g., an IP address) of an ECS. The determination may be based on an FQDN that may be configured by a user (e.g., via GUI), an FQDN that may be derived from a VPLMN ID or an HPLMN ID, an FQDN that may be pre-configured in an application client, and/or an FQDN that may be pre-configured in an EEC. The EEC may use the FQDN to perform a DNS look up and determine an IP address of an ECS.

The EEC may send a service provisioning request to the IP address of the ECS to obtain a list of EDN configuration information. The service provisioning procedure may be enhanced so that an ECS may return the ECS address configuration information for alternate ECS(s) that may be able to provision the EEC.

The enhancement to the service provisioning procedure may allow the EEC to use an identifier (e.g., a single identifier such as an FQDN) to determine multiple sets of ECS address configuration information. The EEC may be triggered by the ECS, e.g., which was identified by the single identifier, to perform the service provisioning procedure with multiple other ECS, which are identified by the ECS address configuration information.

The ECS may be an ECS that may be configured to respond (e.g., always respond) to the service provisioning request with one or more sets of ECS address configuration information.

The ECS may use information in the EEC's service provisioning request to determine to respond to the EEC with one or more sets of ECS address configuration information. For example, the service provisioning request may have included connectivity information. The connectivity information may have indicated the SSID and/or PLMN ID that the WTRU may be using to obtain network connectivity. The ECS may use the SSID and/or PLMN ID to determine what ECS address configuration information to send to the WTRU. For example, the ECS address configuration information that may be sent to the WTRU may be accessible to a WTRU if the WTRU is registered via the PLMN that was identified in the service provisioning request.

Based on receiving the EEC's service provisioning request, the ECS may use the NEF's Nef_EventExposure_Subscribe service operation to indicate to the NEF that the ECS wants to be notified when the WTRU that hosts the EEC is roaming and that the ECS wants to be notified of the WTRU's PLMN ID. If the information is provided to the ECS, the ECS may use the VPLMN ID to determine what ECS address configuration information to send to the WTRU.

The EEC's service provisioning request may include location information. The ECS may use the WTRU's location information to determine what ECS address configuration information to send to the WTRU. For example, the ECS may determine that a nearby VPLMN may be capable of providing services that the EEC may want to access and the ECS may send the ECS address configuration information so that the EEC may use the information to perform the service provisioning procedure with the other ECS(s).

The ECS may act as an SOR-AF and provide updated SoR Information to the UDM. The UDM may provide the SoR information to the AMF so that it may be delivered to the WTRU via an NAS message as described herein. Reception of the SoR transparent container may trigger the WTRU to move to a VPLMN (e.g., new VPLMN) and indicate to the EEC that the WTRU is now registered in the new VPLMN so that the EEC knows to use the ECS address configuration information that was received from the ECS and is associated with the VPLMN (e.g., new VPLMN).

As described herein and shown in Table 2, the ECS address configuration information may have been enhanced with a PLMN ID and/or a DNN/S-NSSAI combination. The EEC may use the DNN/S-NSSAI combination to establish a PDU Session and may execute a service provisioning procedure with an ECS of the VPLMN (e.g., new VPLMN).

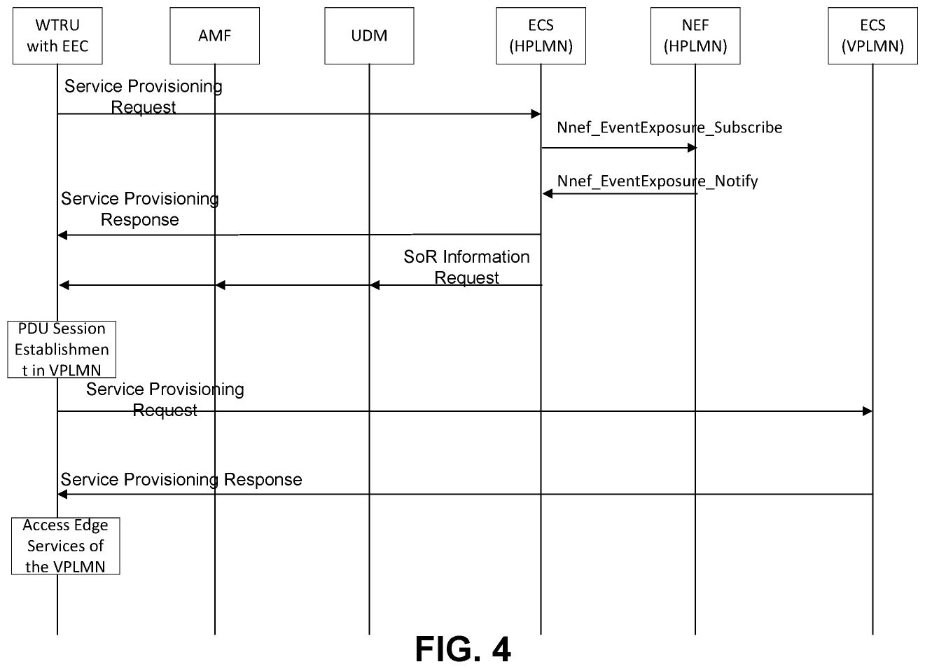

FIG. 4 depicts an example flow for discovery of VPLMN ECS information and connection establishment with SoR. As shown in FIG. 4, a procedure for how the EEC may execute an enhanced service provisioning procedure with an ECS in the HPLMN may be provided. The HPLMN may steer the WTRU to roam to another PLMN to allow the WTRU to connect and receive provisioning information from an ECS in the VPLMN.

As described with respect to FIG. 4, an EEC may send a service provisioning request to the ECS. The request may include connectivity information such as a PLMN ID and/or SSID. The ECS may use the Nnef_EventExposure service of the NEF to request the roaming status of the WTRU, the ID of the PLMN that the WTRU is registered with, and/or the WTRU's location. The ECS may receive a notification of whether the WTRU is roaming, the identity of the PLMN that the WTRU is registered to, and/or the WTRU's location. The ECS may use the PLMN ID and/or location information that was received to determine to send ECS address configuration information for other ECS(s) that may be able to provision the EEC. The other ECS(s) may be ECS(s) that may be better suited to serve the WTRU based on the WTRU's current location or the PLMN that the WTRU is registered to. The ECS, e.g., acting as an SOR-AF, may send a transparent SoR container to the WTRU. The transparent SoR container may be used to steer the WTRU towards a VPLMN that is associated with the ECS address configuration information that was provided to the WTRU as described herein. The WTRU may use the DNN/S-NSSAI combination that was received to establish a PDU session. The PDU session may be an LBO session (e.g., anchored in the VPLMN). The EEC may use the PDU session to communicate with an ECS in the VPLMN and execute a service provisioning procedure. The WTRU may be able to access the edge services (e.g., EES(s) of the VPLNM.

NAS-based redirection may be provided. As described herein, an SoR-AF of the home network may provide the WTRU with preferred PLMN/access technology combination(s). An ECS in the home network may act as an SoR-AF. In such a case, the WTRU may be steered to a VPLMN to obtain desired services. The desired services may be edge-based services. The SoR-AF may send ECS address configuration information to the WTRU. For example, the SOR transparent container may be enhanced to carry the information from Table 2 to the WTRU.

The information from Table 2 that is received in the SOR transparent container may be used by the WTRU in a PLMN selection procedure. For example, the WTRU may choose to assign lower priority to PLMN(s) that may not be associated with an ECS. For example, the SOR transparent container may list 3 PLMN/access technology combinations that are not associated with an ECS address configuration information (e.g., any ECS address configuration information) and the SOR transparent container may list 2 PLMN/access technology combinations that are associated with ECS address configuration information. If an EEC is installed on the WTRU and accessing edge services, the WTRU may choose to prioritize the 2 PLMN/access technology combinations that are associated with ECS address configuration information.

After performing PLMN selection and registering to one of the PLMNs that may be associated with ECS address configuration information, the WTRU may use a DNN/S-NSSAI combination from the ECS address configuration information to establish a PDU Session. The WTRU may use an FQDN and/or IP Address from the ECS address configuration information to contact the ECS and/or perform a service provisioning procedure. The WTRU may receive the FQDN or IP Address in the PDU session establishment accept message.

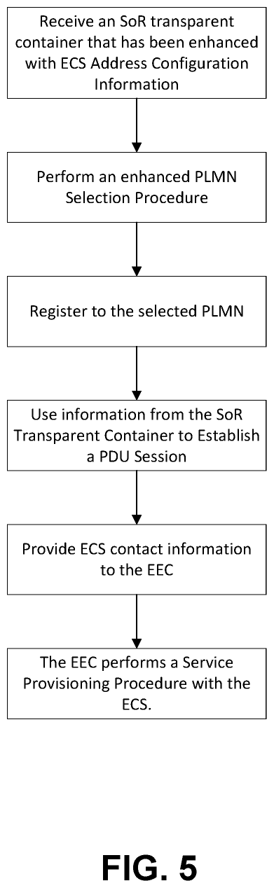

FIG. 5 depicts an example flow for moving a WTRU to a VPLMN and obtaining access to an ESC. As shown in FIG. 5, a procedure for a WTRU may use steering of roaming information to discover an ECS in a VPLMN. The WTRU may receive a transparent SoR container from a first PLMN that has been enhanced with ECS address configuration information (e.g., the contents of Table 1). The WTRU may use the information from the SoR container to perform an enhanced PLMN selection procedure where the WTRU prioritizes PLMN(s) based on the ECS(s) that the PLMN may provide access to. The WTRU may use ECS address configuration information to determine what services a PLMN may provide access to. The WTRU may perform a registration procedure with the selected PLMN. The selected PLMN may be different than the first PLMN. The WTRU may use the DNN/S-NSSAI combination from the ECS address configuration information to establish a PDU Session in the selected PLMN that may be used to communicate with an ECS of the selected PLMN. The MT part of the WTRU may provide ECS contact information to the EEC. The EEC may use the PDU session to communicate with an ECS in the selected PLMN (i.e., a VPLMN) and execute a service provisioning procedure.

The WTRU may receive a list of equivalent PLMNs from the AMF and the list may be enhanced so that it includes the ECS address configuration information that is listed in Table 2.

Accordingly, systems, methods, and instrumentalities have been disclosed for receiving requests from a WTRU to be notified that a type of network node has become available to the WTRU in a visited public land mobile network (PLMN) and for providing configuration information for creating a session with a network node of the type in the visited PLMN. A network node, which may be, for example, an Edge Configuration Server (ECS), may be associated with a first PLMN and may be configured to receive a first message from the WTRU. The first message may indicate a request to be notified if a type of network node becomes available to be accessed by the WTRU. The network node may receive a second message from a second network node which may be, for example, a Network Exposure Function (NEF). The second message may indicate an identity of a second PLMN and may indicate that the WTRU is registered with the second PLMN. The network node may determine a third network node of the type of network node is available to be accessed by the WTRU in the second PLMN. The third network node may be, for example, an ECS. The network node may determine service provisioning information that the WTRU may use to access the third network node. For example, the network node may determine local breakout (LBO) information which may comprise information for the WTRU to establish a LBO packet data unit (PDU) session in the second PLMN and communicate with the third network node.

Although features and elements described herein are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-32. (canceled)

33. A wireless transmit and receive unit (WTRU) comprising:
a processor configured to:
send a first message to a network node associated with a first public land mobile network (PLMN), the first message indicating a request for service provisioning;
receive a second message from the network node, the second message comprising an identifier of an edge configuration server (ECS) in a second PLMN serving the WTRU and comprising at least one of a data network name (DNN) for establishing a PDU session for contacting the ECS in the second PLMN or single-network slice selection assistance information (S-NSSAI) for establishing a PDU session for contacting the ECS in the second PLMN; and
establish a PDU session with the ECS in the second PLMN using at least one of the DNN or S-NSSAI.

34. The WTRU of claim 33,
wherein the processor configured to send the first message to the network node associated with a first PLMN is further configured to send the first message to an ECS in the first PLMN.

35. The WTRU of claim 34,
wherein the ECS in the first PLMN is a home ECS.

36. The WTRU of claim 33,
wherein the first message comprises a service provisioning subscription request.

37. The WTRU of claim 33,
wherein the second message from the network node comprises a notification to redirect the WTRU to the ECS in the second PLMN.

38. The WTRU of claim 33,
wherein the identifier of the ECS in the second PLMN serving the WTRU comprises an address of the ECS in the second PLMN serving the WTRU.

39. The WTRU of claim 33,
wherein the processor configured to establish the PDU session with the ECS in the second PLMN using at least one of the DNN or the S-NSSAI is further configured to establish the PDU session with the ECS in the second PLMN using the DNN and the S-NSSAI.

40. The WTRU of claim 33, wherein the WTRU comprises an edge enabler client (EEC).

41. A method comprising:
a wireless transmit and receive unit (WTRU) sending a first message to a network node associated with a first public land mobile network (PLMN), the first message indicating a request for service provisioning;
the WTRU receiving a second message from the network node, the second message comprising an identifier of an edge configuration server (ECS) in a second PLMN serving the WTRU and comprising at least one of a data network name (DNN) for establishing a PDU session for contacting the ECS in the second PLMN or single-network slice selection assistance information (S-NSSAI) for establishing a PDU session for contacting the ECS in the second PLMN; and
the WTRU establishing a PDU session with the ECS in the second PLMN using at least one of the DNN or S-NSSAI.

42. The method of claim 41,
wherein sending the first message to the network node associated with a first PLMN comprises sending the first message to an ECS in the first PLMN.

43. The method of claim 42,
wherein the ECS in the first PLMN is a home ECS.

44. The method of claim 41,
wherein the first message comprises a service provisioning subscription request.

45. The method of claim 41,
wherein the second message from the network node comprises a notification to redirect the WTRU to the ECS in the second PLMN.

46. The method of claim 41,
wherein the identifier of the ECS in the second PLMN serving the WTRU comprises an address of the ECS in the second PLMN serving the WTRU.

47. The method of claim 41,
wherein establishing the PDU session with the ECS in the second PLMN using at least one of the DNN or the S-NSSAI further comprising establishing the PDU session with the ECS in the second PLMN using the DNN and the S-NSSAI.

48. A network node comprising:
a processor configured to:
receive a first message from a wireless transmit and receive unit (WTRU) associated with a first public land mobile network (PLMN), the first message indicating a request for service provisioning;
send a request to subscribe to a roaming status of the WTRU;
receive an indication the WTRU is roaming and an identity of a second PLMN serving the WTRU;
determine an edge configuration server (ECS) in the second PLMN serving the WTRU;
send a second message to the WTRU, the second message comprising an identifier of the ECS in the second PLMN serving the WTRU and comprising at least one of a data network name (DNN) for establishing a PDU session for contacting the ECS in the second PLMN or single-network slice selection assistance information (S-NSSAI) for establishing a PDU session for contacting the ECS in the second PLMN;

49. The network node of claim 48,
wherein the processor configured to receive the first message from the WTRU associated with the first PLMN is further configured to receive a service provisioning subscription request.

50. The network node of claim 48,
wherein the processor configured to send the request to subscribe to the roaming status of the WTRU is further configured to invoke a network exposure function (NEF) to subscribe to the roaming status of the WTRU.

51. The network node of claim 48,
wherein the processor configured to receive the indication the WTRU is roaming and the identity of the second PLMN serving the WTRU is further configured to receive an NEF notification comprising the indication the WTRU is roaming and the identify of the second PLMN serving the WTRU.

52. The network node of claim 48,
wherein the identifier of the ECS in the second PLMN serving the WTRU comprises an address of the ECS in the second PLMN serving the WTRU.
